(19) United States
(12) Patent Application Publication
(10) Pub. No.: US 2009/0107976 A1
(43) Pub. Date: Apr. 30, 2009

(54) Applicator for Decorative Objects

(75) Inventor: Andreas Franken, Detmold (DE)

Correspondence Address: RICHARD M. GOLDBERG, 25 EAST SALEM STREET, SUITE 419, HACKENSACK, NJ, 07601, US

(73) Assignee: VIVA-DECOR GMBH, Bad Salzuflen (DE)

(21) Appl. No.: 11/944,569

(22) Filed: Nov. 23, 2007

(30) Foreign Application Priority Data
Oct. 24, 2007 (DE) 10 2007 050 852.4

(51) Int. Cl. H05B 3/42; H05B 3/02

(52) U.S. Cl. 219/229; 219/227

(57) ABSTRACT

An applicator for decorative objects, includes a heating rod (14) projecting from a handle (12) and carrying at a free end thereof a suction head (20), a suction line (22) that passes from the suction head through the heating rod and the handle and is connected to a subatmospheric pressure source (24), and the handle (12) is provided with a vent hole (36) that is connected to the suction line (22) and adapted to be closed with a finger.

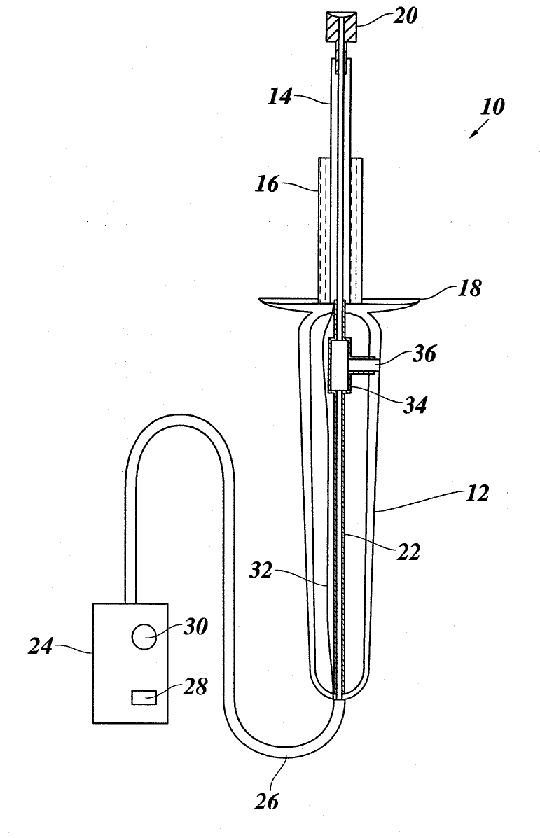

The invention relates to an applicator for decorative objects, comprising a heating rod projecting from a handle and carrying, at a free end thereof, a suction head, the applicator further comprising a suction line that passes from the suction head through the heating rod and the handle and is connected to a subatmospheric pressure source.

In the past, the applicant has used an applicator of this type for applying decorative objects such as gems, sequins and the like, on substrates, e.g. on clothing or other textile materials.

On the side with which they are to be applied to the substrate, the decorative objects are coated with a hot-melt adhesive, and when the subatmospheric pressure has been switched on, they may be picked up with the applicator, so that the heat generated by the heating rod is transferred by thermal conduction through the decorative object to the hot-melt adhesive to make the same tacky. Then, the decorative object is placed on the desired location on the substrate by means of the applicator and is released by switching off the subatmospheric pressure, so that the decorative object remains on the substrate and is fixed thereon when the adhesive is cured.

It is an object of the invention to provide an applicator of this type which is more easy to operate.

According to the invention, this object is achieved by the feature that the handle is provided with a vent hole that is connected to the suction line and adapted to be closed with a finger.

As long as the vent hole is left open, the suction line is vented even when the subatmospheric pressure source is switched on, and, accordingly, the suction head is not operating. When the user wants to pick up a decorative object, he only has to place the suction head on the object and then to close the vent hole with one finger of the hand holding the handle, whereby a subatmospheric pressure is created in the suction line and the object is picked up by the suction head. Likewise, the decorative object may easily be placed on the desired location on the substrate by removing the finger from the vent hole.

In this way, the user is no longer required to copiously switch the subatmospheric pressure source on and off in order to make the suction head operative and inoperative, respectively.

Advantageous embodiments of the invention are indicated in the dependent claims.

An embodiment example will now be explained in conjunction with the drawing.

The single drawing FIGURE shows a schematic cross-section of an applicator according to the invention.

The applicator 10 shown in the drawing has an elongated handle 12 that can be gripped with one hand and is made of a material that is heat resistant but has a low heat conductivity. The outer surface of the handle 12 is formed by a layer of a soft non-slip plastic that becomes thicker towards the front end of the handle.

An electric heating rod 14 projects from the front end of the handle 12, and a portion of this heating rod adjacent to the handle 12 is surrounded by a thermally insulating protection pipe 16 and a protective shield 18 formed by the handle. The shield 18 serves as a heat shield and at the same time as a support which permits to deposit the applicator on a support surface in such a manner that the heating rod 14 will not contact the support surface.

An interchangeable, heat-conductive suction head 20 that is adapted to the specific shape of the decorative objects to be applied and has a heat-resistant non-stick coating, e.g. of PTFE is provided at the free end of the heating rod 14. The interchangeable suction head 20 is connected to a suction line 22 that passes through the heating rod 14 and the interior of the handle 12 and leads to the rear end of the handle 12 where it is connected to a supply line 26 leading from a subatmospheric pressure source 24.

In the example shown, the subatmospheric pressure source 24 is formed by a control apparatus that can be connected to a mains supply and includes a pump for generating the subatmospheric pressure as well as a mains adapter for supplying power to the heating rod 14. As the case may be, a thermostatic control for the heating rod may be integrated. The heating rod can be switched on and off with a switch 28, and a regulator 30 is provided for controlling the displacement of the pump and hence the subatmospheric pressure.

The supply line 26 is formed by a flexible hose, and electrical leads for connecting the mains adapter to the heating rod 14 are integrated in the wall of that hose.

Inside of the handle 12, the suction line 22 passes through a T-piece 34 the branched-off leg of which leads to a vent hole 36 formed in the surface of the handle 12. The vent hole 36 is arranged in the thickened end of the handle 12 near the protective shield 18 in such a manner that it may conveniently be opened and closed, for example with the thumb or forefinger, when the user holds the handle 12 in his hand like a stylus.

The cross-sectional area of the vent hole is dimensioned such that, even when the subatmospheric pressure source 24 is operating with maximum power, the subatmospheric pressure in the suction line 22 is collapsed completely as long as the user does not close the vent hole. Moreover, the power of the pump in the subatmospheric pressure source 24 and the cross-sections of the suction line 22 and the vent hole 36 are so adapted that, when the pump is running, the air current does not produce any substantial disturbing noise, and the pump itself operates at very low noise. The power of the pump is controlled with the regulator 30, so that the subatmospheric pressure is just sufficient for picking up the decorative objects with the suction head 20.

What is claimed is:

1. An applicator for decorative objects, comprising:
a handle,
a heating rod projecting from the handle,
a suction head at a free end of the heating rod,
a suction line that passes from the suction head through the heating rod and the handle and is adapted to be connected to a subatmospheric pressure sources,
wherein the handle is provided with a vent hole that is connected to the suction line and adapted to be closed with a finger.

2. Applicator according to claim 1, wherein the handle has an elongated stylus-like shape.

3. Applicator according to claim 1, wherein the suction line is connected, at an end of the handle opposite to the heating rod, to a flexible supply line that is itself adapted to be connected to the subatmospheric pressure source.

4. Applicator according to claim 1, further comprising the subatmospheric pressure source, and a switch for switching the heating rod on and off is provided at the subatmospheric pressure source.

5. Applicator according to claim 1, further comprising the subatmospheric pressure source and wherein the subatmospheric pressure source comprises a regulator for controlling subatmospheric pressure.
